(19) United States
(12) Patent Application Publication
(10) Pub. No.: US 2013/0290867 A1
(43) Pub. Date: Oct. 31, 2013

(54) Systems and Methods For Providing Dynamic and Interactive Viewing and Control of Applications

(71) Applicant: Deepak Massand, McLeansville, NC (US)

(72) Inventor: Deepak Massand, McLeansville, NC (US)

(73) Assignee: Litera Technologies, LLC, McLeansville, NC (US)

(21) Appl. No.: 13/799,573

(22) Filed: Mar. 13, 2013

Related U.S. Application Data
(60) Provisional application No. 61/639,290, filed on Apr. 27, 2012.

(51) Int. Cl. G06F 3/0484; G09G 5/00

(52) U.S. Cl. CPC G06F 3/04842; G09G 5/003
USPC 715/750; 345/619

(57) ABSTRACT

Systems and methods are disclosed that provide multiple user control for multiple active applications displayed on a display device arrangement. Systems and methods are also disclosed that provide dynamic control of the direction of one or more image elements that emit signals used to render images on the display device. Other aspects of the disclosed embodiments are described herein.

This application claims priority to U.S. Provisional Application No. 61/639,290, filed on Apr. 27, 2012, the disclosure of which is herein incorporated by reference in its entirety.

### FIELD

Disclosed embodiments generally relate to computer systems and computer system display devices and processes, and more particularly, to a process and system for providing dynamic and interactive viewing and control of software applications.

### BACKGROUND

Currently, computer systems and devices that execute software applications only allow a single application to be active while displayed on a display device. When a user wishes to switch between different windows for a single application, or between applications, conventional systems only allow a single application or window to be active, which enables the user to manipulate the application for that active window.

Further, conventional systems that provide displays through existing technologies, such as LED displays, are limited to providing static viewing from various angles. While certain technologies provide user friendly viewing from a certain range of viewing angles, the image display elements providing the images, such as the individual LEDs, are static, thus limiting the ability for users to view content on the displays from different angles.

Therefore it is desirable to provide a system and process that enables one or more users to manipulate and control multiple software programs executed by a computer system such that more than one application or window providing content is active on the system's display device(s). Further, it is desirable to provide an interactive and dynamic display system where the image elements that emit signals that form images may be selectively and dynamically adjusted to provide multiple users the ability to view different areas of a display device from different angles and orientations.

### SUMMARY

Disclosed embodiments include, for example, a computer system configured to execute software to provide multiple applications in an active state such that one or more users may manipulate and use the applications simultaneously on a single display arrangement. The display arrangement may include a single display device or may include multiple display devices concatenated to operate as a single display device. In one example, the computer system may use multiple processors or processing core technologies to enable the computer system to provide control to an active application by a first user while at the same time providing control to another active application (or a plurality of other active applications) by a second user (or a plurality of other users, or the first user). In one aspect, the plurality of applications may be active and displayed as active applications on a single display arrangement provided by the computer system. In other embodiments, the computer system may use virtual processing technologies that provide multiple processing capabilities through virtual machines, logical processes and logical processors, and the like.

Disclosed embodiments also provide a system and process that enables image elements of a display device to be dynamically adjusted (individually or as a group of elements) such that images emitted from those image elements for different areas of a display arrangement can be adjusted. In one example, a display system is disclosed that includes a display area including a set of image elements that emit signals that make up images displayed in the display area, such as in a light-emitting diode (LED) display device. Each image element (e.g., LED) may be configured with a movable mount included on flexible substrates that can be mechanically, magnetically and/or electronically moved to emit the signals in selected directions. In another embodiment, subsets of the image elements may be controlled such that a group of image elements (e.g., one or more rows or columns of LEDs) may be physically adjusted to adjust the angle of emission of the signals emitted by the image elements in the group. In certain embodiments, one or more image elements may be combined and may be adjusted to provide a more direct viewing angle in one direction and/or orientation while at the same time other image elements in the same display are adjusted to provide a different viewing angle in a different direction and/or orientation. In this manner, a first user can view a portion of the content displayed by the display device in the system while at the same time a second user (or a plurality of other users) can view different content displayed by the display device in the system.

Disclosed embodiments also enable a user to selectively change the number, positioning, and orientation of various application display areas within a display arrangement. Moreover, disclosed embodiments enable a user to connect other devices to the computer system controlling the display arrangement, such that the processing power of the device can be joined with the computer system and/or such that the user can interact with the device via the display arrangement just as if the user were interacting directly with the device.

Consistent with other disclosed embodiments, tangible computer-readable storage media may store program instructions that are executable by a processor to implement any of the processes disclosed herein.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the disclosed principles. In the drawings:

FIG. 1A is a diagram of an exemplary computer system that may be used to implement the disclosed embodiments.

FIG. 2 is a diagram of an exemplary display arrangement including two active applications simultaneously displayed on a display device, consistent with disclosed embodiments.

FIG. 3 is a diagram of a multiple user interactive display system consistent with disclosed embodiments.

FIG. 4 is a flow chart of an exemplary multiple user control process that may be performed by disclosed embodiments.

FIG. 5 is a diagram of an exemplary display device arrangement consistent with disclosed embodiments.

FIG. 6 is a diagram of another exemplary display device arrangement consistent with disclosed embodiments.

FIG. 7 is a diagram of an exemplary display system that interfaces with multiple users, consistent with disclosed embodiments.

FIG. 8A is a diagram of an exemplary image element mount that is dynamically adjustable in accordance with disclosed embodiments.

FIG. 8B shows diagrams of an exemplary image element mount demonstrating different signal emission angles in accordance with disclosed embodiments.

FIG. 9 is a diagram of exemplary image elements adjusted to emit signals in different directions and/or orientations, consistent with disclosed embodiments.

### DESCRIPTION OF THE EMBODIMENTS

Reference will now be made in detail to exemplary embodiments, examples of which are illustrated in the accompanying drawings and disclosed herein. Wherever convenient, the same reference numbers will be used throughout the drawings to refer to the same or like parts.

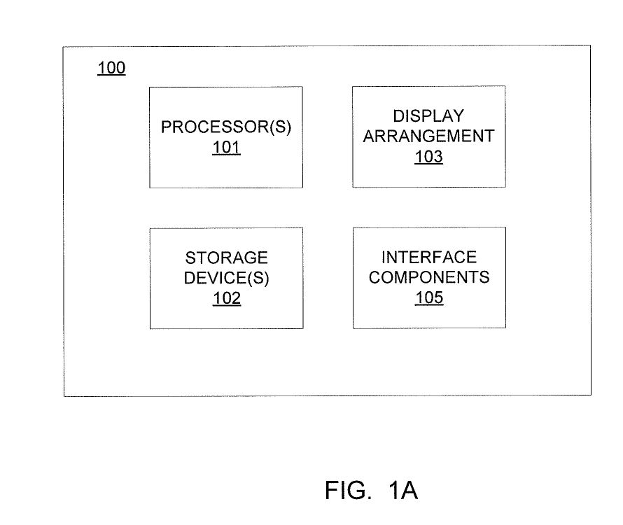

FIG. 1A shows an exemplary computer system that is configured to perform one or more software processes that, when executed, provide one or more aspects of the disclosed embodiments. The components and arrangement shown in FIG. 1A are not intended to be limiting to the disclosed embodiment as the components used to implement the processes and features disclosed here may vary.

In accordance with certain disclosed embodiments, a computer system 100 may be provided that includes one or more processor(s) 101, one or more storage device(s) 102, a display arrangement 103, and interface components 105. Other components known to one of ordinary skill in the art to be included in computer systems are also included in system 100, but are not shown. In one embodiment, computer system 100 may be a general purpose or notebook computer, a mobile device with computing ability, a server, a mainframe computer, or any combination of these computers and/or affiliated components. In certain aspects, computer system 100 may be configured as a particular computer system when executing software to perform one or more operations consistent with disclosed embodiments. Computer system 100 may communicate with a network (such as the Internet, a LAN, etc.) through I/O devices (not shown). For example, computer system 100 may establish a direct communication link with a network, such as through a LAN, a WAN, or other suitable connection that enables computer system 100 to send and receive information, as described herein. Computer system 100 may be a standalone system or may be part of a subsystem, which may, in turn, be part of a larger system, such as a networked desktop emulator. Computer system 100 may also be implemented as a display device system, such as a television, tabletop display system, wall mounted display devices (e.g., billboards, large screen displays, etc.), and the like. In such configurations, system 100 may include components known to be used to provide functionalities for such display device systems.

Processor(s) 101 may be one or more known processing devices, such as a microprocessor from the Pentium™ family manufactured by Intel™ or the Turion™ family manufactured by AMD™. Processor(s) 101 may include a single core or multiple core processor system that provides the ability to perform parallel processes simultaneously. For example, processor 101 may be a single core processor that is configured with virtual processing technologies known to those skilled in the art. In certain embodiments, processor 101 may use logical processors to simultaneously execute and control multiple processes. Processor 101 may implement virtual machine technologies, or other similar known technologies to provide the ability to execute, control, run, manipulate, store, etc. multiple software processes, applications, programs, etc. In another embodiment, processor(s) 101 may include a multiple core processor arrangement (e.g., dual or quad core) that is configured to provide parallel processing functionalities to allow system 100 to execute multiple processes simultaneously. One of ordinary skill in the art would understand that other types of processor arrangements may be implemented to provide for the capabilities disclosed herein.

Storage device(s) 102 may be configured to store information used by processor 101 (or other components) to perform certain functions related to disclosed embodiments. In one example, storage device(s) 102 may include a memory that includes instructions that enable processor(s) 101 to execute one or more applications, such as a word processing application, a spreadsheet application, an Internet browser application, and any other type of application or software known to be available on computer systems, such as a desktop, laptop, server, mobile device, or other types of computer systems. Alternatively, the instructions, application programs, etc., may be stored in an external storage or available from a memory over a network. Storage device(s) 102 may be a volatile or non-volatile, magnetic, semiconductor, tape, optical, removable, nonremovable, or other type of storage device or tangible computer-readable medium.

In one embodiment, storage device(s) 102 may include a memory storing software that, when executed by processor(s) 101, enables processor(s) 101 to perform one or more processes consistent with the functionalities disclosed herein. Methods, systems, and articles of manufacture consistent with disclosed embodiments are not limited to separate programs or computers configured to perform dedicated tasks. For example, storage device(s) 102 may include a memory that may include one or more programs that enable processor(s) 101 to perform one or more functions of the multiple user display control features of the disclosed embodiments. Alternatively, the memory may include multiple programs that enable processor(s) 101 to perform one or more functions of the dynamic image element adjustment features of the disclosed embodiments. Moreover, processor(s) 101 may execute one or more programs located remotely from system 100. For example, system 100 may access one or more remote programs, that, when executed, enable processor(s) 101 to perform functions related to disclosed embodiments.

Storage device(s) 102 may also store one or more operating systems that perform known operating system functions when executed by system 100. By way of example, the operating systems may include Microsoft Windows™, Unix™, Linux™, Apple™ Computers type operating systems, Personal Digital Assistant (PDA) type operating systems, such as Microsoft CE™, or other types of operating systems. Accordingly, embodiments of the disclosed invention will operate and function with computer systems running any type of operating system.

Computer system 100 may also include one or more interface components 105 that may comprise one or more interfaces for receiving signals or input from input devices and providing signals or output to one or more output devices that allow data to be received and/or transmitted by system 100. For example, system 100 may include interface components 105 that may provide interfaces to one or more input devices, such as one or more keyboards, mouse devices, and the like, that enable system 100 to receive data from one or more users, such as selection of an active application, selection of a functionality, selection of one of a plurality of open processes, etc. Further, interface components 105 may provide interfaces to one or more output devices, such as a display screen, CRT monitor, LCD monitor, LED monitor, plasma display, printer, speaker devices, and the like, to enable system 100 to present data to a user. Interface components 105 may also include one or more digital and/or analog communication input/output devices that allow system 100 to communicate with other machines and devices. The configuration and number of interface components 105 incorporated in system 100 may vary as appropriate for certain embodiments. In one embodiment, interface components 105 may be configured within display arrangement 103 (described below) that provide for touch screen capabilities or other forms of user input/output functionalities.

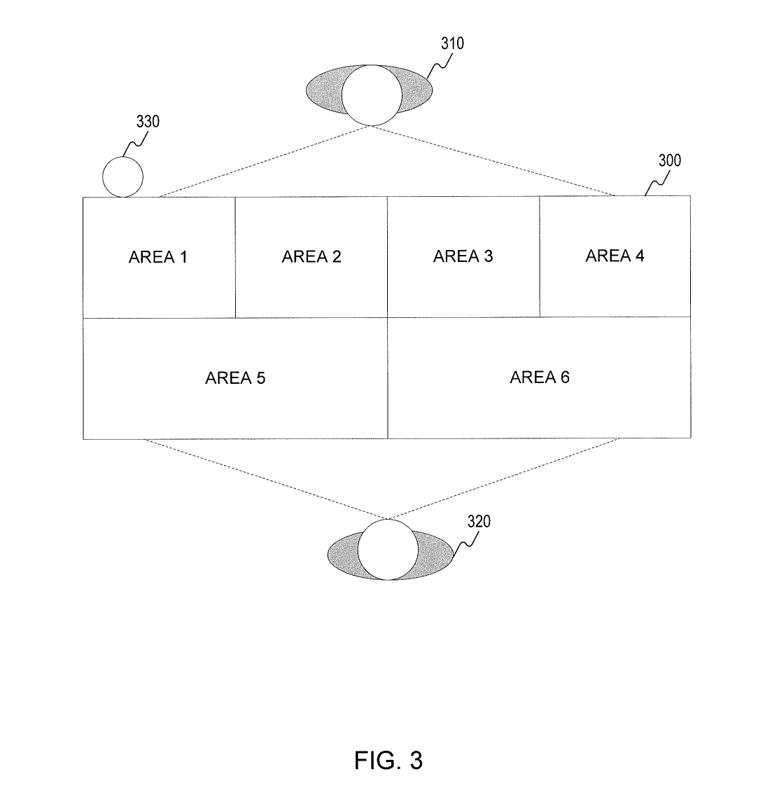

For example, interface components 105 may include a docking station that enables a user to connect a device such as a tablet, laptop, smart device, smartphone, gaming console, etc., to system 100. When a device is connected to system 100, one or more processors within the connected device processor may interact with and/or join the processor(s) within system 100 such that greater processing power may become available. Additionally, a portion of the display arrangement of system 100 may automatically display the content being displayed on the device and allow the user to use this device's full functionality as if the device were an integrated part of the computer (discussed in greater detail below with regard to FIG. 3).

Computer system 100 may also be communicatively connected to one or more databases (not shown) locally or through a network. The databases store information and are accessed and/or managed through system 100. By way of example, the databases may be document management systems, Microsoft SQL databases, SharePoint databases, Oracle™ databases, Sybase™ databases, or other relational databases. The databases may include, for example, data and information related to the application programming interface (API) of child applications, such as functions performed by the child applications, parent applications compatible with the functions, parameters required by the functions, etc. Systems and methods of disclosed embodiments, however, are not limited to separate databases or even to the use of a database.

Display arrangement 103 may be one or more display devices that render information for viewing by one or more users. In one embodiment, display arrangement 103 may be a LED display device that uses a set of LED image elements that emit signals that collectively provide the content viewable by a user. In certain embodiments, display arrangement 103 may be an organic LED (OLED) display device. Other forms of image elements such as touch-screen-enabled flat panels of any kind such as LED, liquid crystal display (LCD), etc., may used in the disclosed embodiments. Display arrangement 103 may be, for example, a single display device (e.g., LED, LCD, etc.) that displays applications that are executed by processor(s) 101, such as windows that display word processing applications, document management applications, and any other type of applications.

In one embodiment, the applications may be simultaneously displayed in an active state. An active application, for example, may represent an application that is capable of being used, manipulated, etc. by a user or a computer process. In one example, an active application may refer to an application that a user may manipulate, and where the operating system's cursor is displayed on the window, and/or where a blinking cursor (for word processing applications) is displayed and controllable by a user. As described below, aspects of the disclosed embodiments enable two or more applications to be executed in active states such that a cursor is shown and controllable for each active application. Certain embodiments enable multiple users to open, use, manipulate, and work on respective applications at the same time as the applications are displayed on the same display device, such as in horizontal display devices (e.g., tabletop display devices, desktop display devices, etc.) and vertical display devices (e.g., monitors, wall mounted display devices, etc.).

In other aspects of the disclosed embodiments, display arrangement may be configured to provide adjustable image elements that may be dynamically adjusted to provide different views in different directions and orientations at the same time.

### MULTIPLE APPLICATION EMBODIMENTS

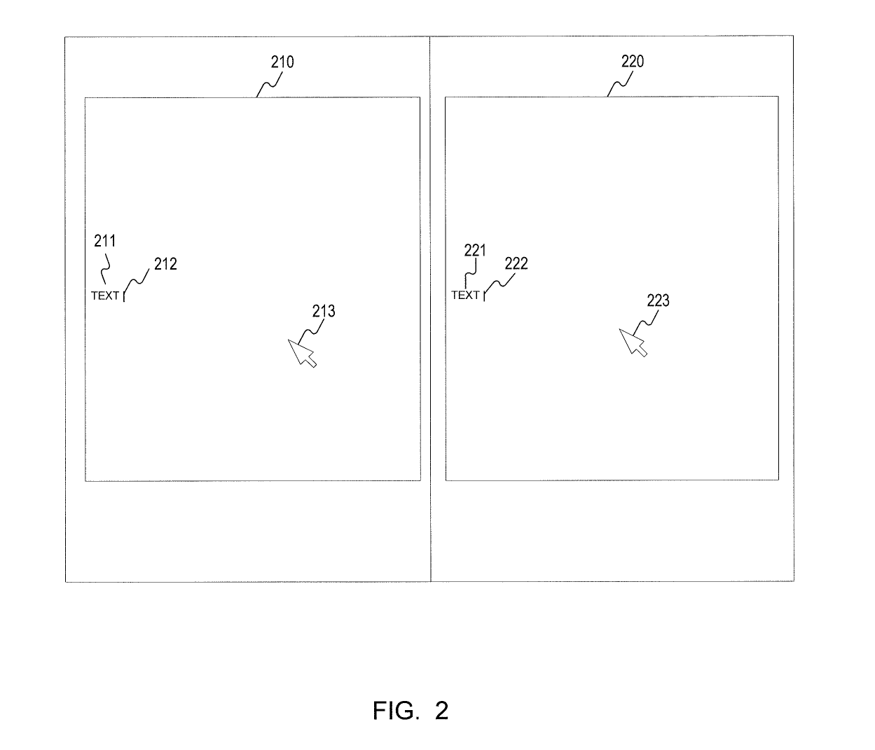

Computer system 100 may be configured to provide processes that, when executed by processor(s) 101, provide multiple active applications on a single display device (or on multiple display devices configured collectively for computer system 100, such as a dual monitor set up). These processes and features provide a single display arrangement where two or more active applications are executed and displayed, such as shown in FIG. 2 as an example and the ability for each active application to be operational and manipulated simultaneously with one or more other active applications.

For example, as shown in FIG. 2, a first application 210 includes text 211 that may be controlled by a user. In this example, the portion of the display device arrangement in FIG. 2 that displays first application 210 includes a blinking cursor 212 and its own cursor 213 for user manipulation. At the same time, second application 220 with text 221 may be displayed with blinking cursor 222 and its own cursor 223. In this example, two or more users may be able to manipulate respective applications at the same time without affecting the execution of the other application or user's manipulation of that application. In this way, two users may share a display arrangement and work on different applications at the same time, such as in a desktop or tabletop display device where multiple users may stand over the display device and manipulate the applications.

FIG. 3 shows a diagram of an exemplary arrangement where two users 310, 320 share use of a display arrangement 300, such as in a tabletop display environment. For example, display arrangement 300 in FIG. 3 may be included in display arrangement 103 as shown in FIG. 1. Aspects of the disclosed embodiments are not limited to such configurations, as desktop displays that rest on a desk (or within a desk such that the display is flush with the desk's top surface) or are mounted on a wall can be used in accordance with the disclosed embodiments. In one example, computer system 100 may provide a request to receive a selection for the number of separate applications to be placed in an active state. Thus, for example, system 100 may provide the ability for a user to select six different active applications that may be displayed by the display arrangement. As shown in FIG. 3, six areas of display arrangement 300 are provided that may each include a different active application. Aspects of the disclosed embodiments may allow a user to select one or more active applications (e.g., 1, 2, 3, 4, 5, 6, 7, 8, 9, 10, etc.). In one embodiment, processor(s) 101 may be configured such that for each active application provided, a respective logical processor, processor core, virtual machine, etc. may be assigned to control and execute the manipulations of the active applications. Thus, in a quad core processor arrangement, a four active application selection may invoke the ability for system 100 to assign control, execution, etc. to each core of the processor(s). In a virtual processor environment, four logical processors may be invoked to handle respective active application use.

In the example shown in FIG. 3, the six active applications may be displayed in discrete areas (1-6) of the display arrangement. Each active application may include its own cursor or other type of user input representation. Thus, user 310 may manipulate an active application in area 1 while user 320 manipulates an active application in area 6. Moreover, aspects of the disclosed embodiments enable a user to use a single input device (e.g., mouse, remote control, etc.) to control different active applications. Such functions may be provided through a selection mechanism programmed with the software associated with the input device to enable the user to switch between controls of different active applications. In touch screen environments, a user may touch the area with the active application to manipulate the application. In certain embodiments, different colors, icons, graphics, etc. may be used to differentiate the active applications and the cursors for those applications. The colors, icons, or graphics may also be user-specific (e.g., user 310 controls yellow cursors and user 320 controls red cursors).

Moreover, while the example shown in FIG. 3 includes a display arrangement with six areas, aspects of the disclosed embodiments enable one or more users to change the number of areas and applications contained therein. For example, with reference to FIG. 3, the display arrangement may enable a user to further divide area 5 into two areas (e.g., creating an area 7). In certain embodiments, the display arrangement may be configured to receive a command from a user, such as the user making a touchscreen command, e.g., sliding a finger or stylus along a line that is used to divide area 5 into two areas. In one embodiment, the display arrangement may be configured to receive a command from a user that indicates that the user desires to split the screen. For example, the user may use a finger or stylus to draw an “S” on a designated command portion of the display arrangement, or within a designated command portion of the area within the display arrangement, indicating that the user desires to split a particular area into one or more sub-areas. Then, the user may make the touchscreen command to indicate how the screen should be split. The display arrangement may also be configured to receive a command from the user that indicates different applications to be included in the new sub-areas. For example, a first active application may be displayed in area 5 of FIG. 3. The display arrangement may receive a command from user 320 to split area 5 into two sub-areas, and may also receive a command from user 320 to open a second active application. Responsive to receiving these commands, the display arrangement may split area 5 into two sub-areas, displaying the first active application in a first sub-area and displaying the second active application in a second sub-area.

Likewise, the user may be able to enter commands via the display arrangement to merge certain areas. For example, the user may draw an “M” on a designated command portion of the display arrangement and then may select two different areas (e.g., area 1 and area 2 in FIG. 3). Responsive to the user selecting the two different areas, the display arrangement may merge the areas into a single area.

In some embodiments, the display arrangement may be configured to automatically change the perspective view of one or more areas within the display arrangement based on the locations of the users interacting with those areas. For example, if user 310 is interacting with an application in area 1 from the location shown in FIG. 3, then the display arrangement may display the application in area 1 in an orientation based on user 310's location (e.g., so that the content in the application is displayed in an upright manner to user 310). Likewise, if user 320 is interacting with an application in area 5 from the location shown in FIG. 3, then the display arrangement may display the application in area 5 in an orientation based on user 320's location. Computer system 100 may determine the locations of the different users using any type of technology such as RFID technology, optical sensor technology, such as using 360-degree cameras, etc.

In the example above, however, the content displayed in area 1 in FIG. 3 may not be readily viewable by user 320 because the content may be displayed upside down from user 320's perspective. Thus, in certain embodiments, the display arrangement may enable a user to rotate the perspective view of one or more areas within the display arrangement, e.g., using one or more commands. For example, user 310 viewing area 1 may desire to share the content in area 1 with user 320 on another side of the display arrangement. Thus, the display arrangement may be configured to receive a command from the user (e.g., drawing a circle with a finger or stylus in area 1 or within a designated command portion of area 1) so that the content within area 1 is rotated toward user 320 on the other side of the display arrangement. In certain embodiments, the command to rotate the content within area 1 may also cause computer system 100 to automatically provide dynamic image element adjustments, e.g., consistent with embodiments discussed below, to enable user 320 to view the content. Using these or other processes, the display arrangement may enable a user (or multiple users) to selectively change the number, positioning, and orientation of various areas within the display arrangement.

Moreover, as discussed above with regard to FIG. 1, system 100 may include a docking station that enables a user to connect a device to system 100. For example, FIG. 3 shows an exemplary docking station 330 through which a user may connect a device. While docking station 330 is shown, those skilled in the art will appreciate that other methods of connecting the device to system 100 may also be used, such as any form of wireless data transfer via one or more of the Bluetooth or IEEE 802.11 protocols, for example. The display arrangement may be configured such that when a user connects a device to system 100, the display arrangement enables the user to view the display of the device on the display arrangement. For example, upon detecting that a user has connected a device to system 100, e.g., via docking station 330, the display arrangement may prompt the user to select an area (e.g., area 1) in which the user desires to display the content being displayed on the connected device. Then, the display arrangement may enable the user to interact with the device via the display arrangement, just as if the user were interacting directly with the device.

Aspects of the disclosed embodiments provide processes that implement security features where one user may have master control over what active application other user(s) may manipulate. In other embodiments, computer system 100 may be configured to execute software that performs automatic processes to automatically open, close, lock, etc. one or more applications based on a profile of a user in a physical vicinity of system 100. For example, disclosed embodiments provide processes, when executed by processor(s) 101, to automatically detect (e.g., via RFID tags, motion sensors, etc.) when a user is located within a determined distance of the display arrangement. In one example, the processor(s) 101 may execute software that receives signals from a component configured to detect wireless device(s) (e.g., RFID tags) or from a motion sensor, etc. and processes the signals in accordance with certain aspects of the disclosed embodiments. For instance, in response to such determination, computer system 100 may determine the identity of the user (e.g., via RFID signals, Bluetooth functionalities, etc.) and check the identity against a profile assigned to the detected user. Based on the user's profile, computer system 100 may open and make active an application for manipulation by the user. Alternatively, computer system 100 may close or lock an application based on the user's profile. For example, if a first user is working on sensitive data displayed by computer system 100, aspects of the disclosed embodiments enable that information to be closed when a second user without authority to view information from the active application enters a room including the display environment. In other aspects (described below), the display may be dynamically adjusted such that the viewing angle of the image elements is changed automatically to prevent the second user from viewing the sensitive information, while still allowing the first user to view the sensitive information.

Aspects of the disclosed embodiments also provide processes that display content based on user preferences for displaying that content. In certain embodiments, computer system 100 may be configured to automatically display preset applications in a preset arrangement responsive to detecting the presence of a particular user. For example, in FIG. 3, user 310 may interact with display arrangement 300 at a time when user 320 is not present in the vicinity of display arrangement 300. User 310 may have a preset preference to display four applications when user 310 is interacting with display arrangement 300. Thus, when only user 310 is interacting with display arrangement 300, the four applications may be displayed, e.g., in areas 1-4, or in areas 1-4 expanded to cover the entire display arrangement 300. When computer system 100 detects that user 320 enters within a determined distance of display arrangement 300, computer system 100 may cause display arrangement 300 to display certain applications in accordance with a preset preference of user 320. For example, applications may automatically be displayed in areas 5 and 6 shown in FIG. 3, in response to detecting that user 320 approaches display arrangement 300 and based on preset preferences of user 320 to automatically display those applications in areas 5 and 6.

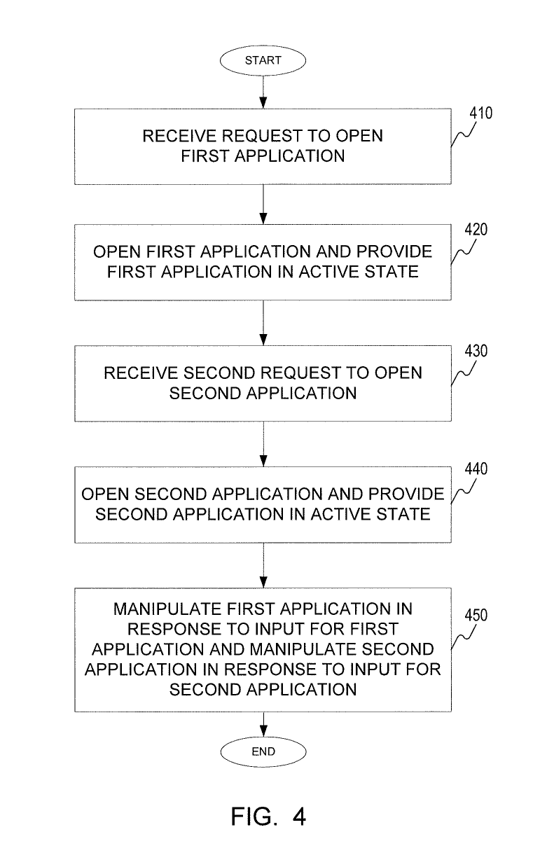

FIG. 4 shows a flow chart of an exemplary process for providing multiple user active application manipulations that may be performed by computer system 100 in accordance with the disclosed embodiments. According to the process of FIG. 4, computer system 100 may receive a request to open a first application (step 410). For example, computer system 100 may receive the request from a user interacting with interface component(s) 105 via one or more input devices discussed above to generate and send a request to computer system 100 to open the first application. This may be accomplished for example, by receiving a signal indicative of a user selecting an icon associated with the first application.

Computer system 100 may open the first application and provide the first application in an active state (step 420). As discussed, an active application, for example, may represent an application that is capable of being used, manipulated, etc. by a user or a computer process. In one example, an active application may refer to an application that a user may manipulate, and where the operating system's cursor is displayed on the window, and/or where a blinking cursor (for word processing applications) is displayed and controllable by a user.

In certain embodiments where display arrangement 103 is capable of displaying multiple active display areas, such as areas 1-6 shown in FIG. 3, computer system 100 may also receive an instruction (e.g., from a user or computer process) to open the first application in its active state within a particular area. Using FIG. 3 as an example, computer system 100 may receive a command from user 310 to open the first application and may also receive a command from user 310 to open the application in area 1 (e.g., by receiving a signal indicative of user 310 touching, clicking on, or moving a cursor or pointer on area 1). Computer system 100 may then open the first application in area 1 responsive to these received commands.

Computer system 100 may also receive a second request to open a second application (step 430). This request may be received, for example, from the same user that opened the first application, from a different user, or from one or more computer processes. In some instances, the first application may generate and send the request to open the second application.

Computer system 100 may open the second application and provide the second application in an active state (step 440). Similar to step 420, computer system 100 may also open the second application in an area designated by a command received at computer system 100. Using FIG. 3 as an example, system 100 may receive a command from user 310 to open the second application in area 2, and may open the second application in area 2 responsive to receiving the command. In certain instances, computer system 100 may receive a command from user 320 to open the second application in area 5, and may open the second application in area 5 responsive to receiving the command.

Computer system 100 may manipulate the first application in response to input received for the first application and also manipulate the second application in response to input received for the second application (step 450). In certain embodiments, the inputs may be received simultaneously or nearly simultaneously, and computer system 100 may manipulate the first application and the second application in response to these inputs simultaneously or nearly simultaneously. Thus, computer system 100 may enable one or more users to interact with the first application and the second application at the same time.

Computer system 100 may repeat steps 430-450 for each request to open subsequent applications (e.g., third, fourth, fifth, etc., applications), such that computer system 100 may enable one or more users to interact with two or more active applications at the same time.

Dynamic Image Elements

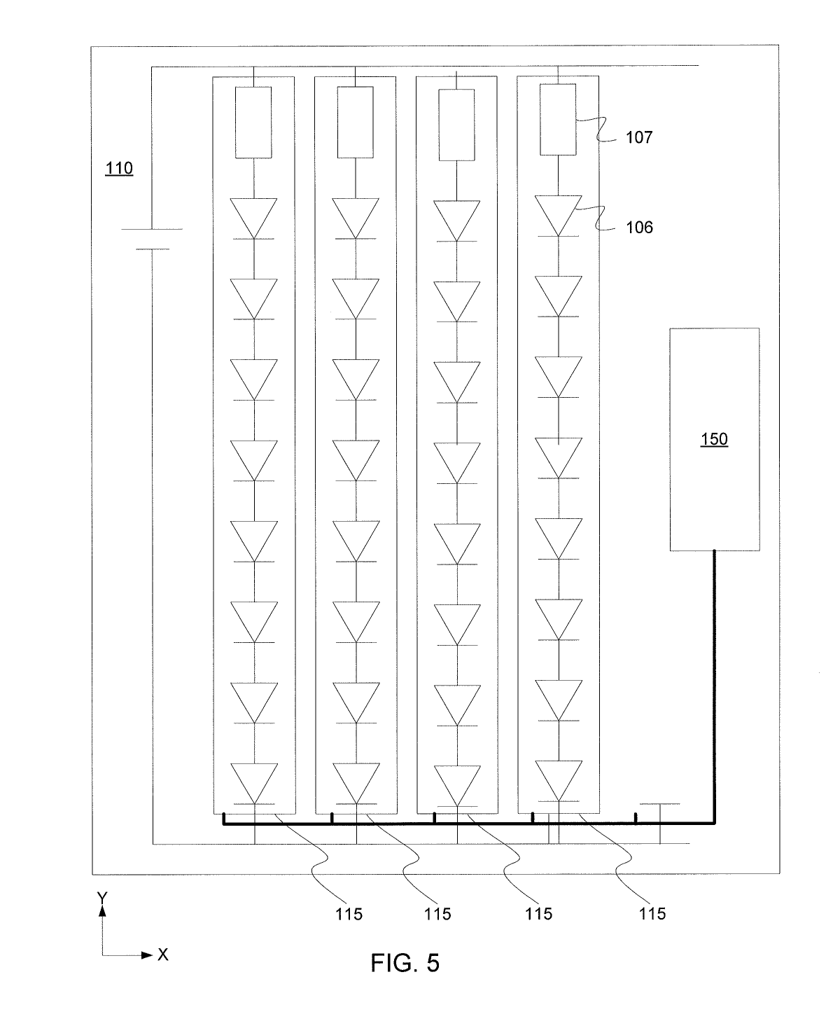

In certain embodiments, computer system 100 may be configured to provide dynamic image element adjustments to control different portions of a display device arrangement. For example, FIG. 5 shows an exemplary display arrangement 110 including a matrix of image elements 106 (e.g., LEDs). Element 107 may be known circuitry that is used to provide known LED display functions, such as one or more resistors, circuitry, etc. Such image display arrangement includes known components that provide known display mechanisms and display functionalities, such as circuitry and components that enable LEDs 106 to provide signals to create images in an LED display device. Other types of image elements 106 may be used consistent with aspect of the disclosed embodiments.

FIG. 5 shows an exemplary processor system 150 that is connected to dynamically adjustable image element mounts 115 for groups of image elements. In one embodiment, processor system 150 may be processor(s) 101. In another embodiment, processor 150 may be one or more other computer processors that execute one or more computer instructions stored in storage device(s) 102 or other computer memory devices to perform the processes described below. For example processor system 150 may perform processes to control the image elements using dynamically adjustable image element mounts 115. In accordance with certain embodiments, processor system 150 (or processor(s) 101) may produce signals that control the angle of image elements 106 by instructing components (not shown) to mechanically, magnetically and/or electronically adjust the position of each image element mount 115. For example, processor system 150 may produce signals to instruct the components to rotate each image element mount 115 a particular angle about an axis in the y-direction as shown in FIG. 5. Thus, one or more groups of image elements 106 may be adjusted by changing the angle of the signals emitted from the image elements. That is, one or more groups of image elements may be directed to point in a direction or orientation different from another group of one or more image elements. In this manner, system 100 may provide the ability to control display device arrangement 110 to provide different views to different users. For example, as discussed, system 100 may detect the presence of one or more users using, e.g., RFID or optical technologies. One or more groups of image elements may be directed to point in a direction of each detected user, based on the application that each particular user is viewing or interacting with.

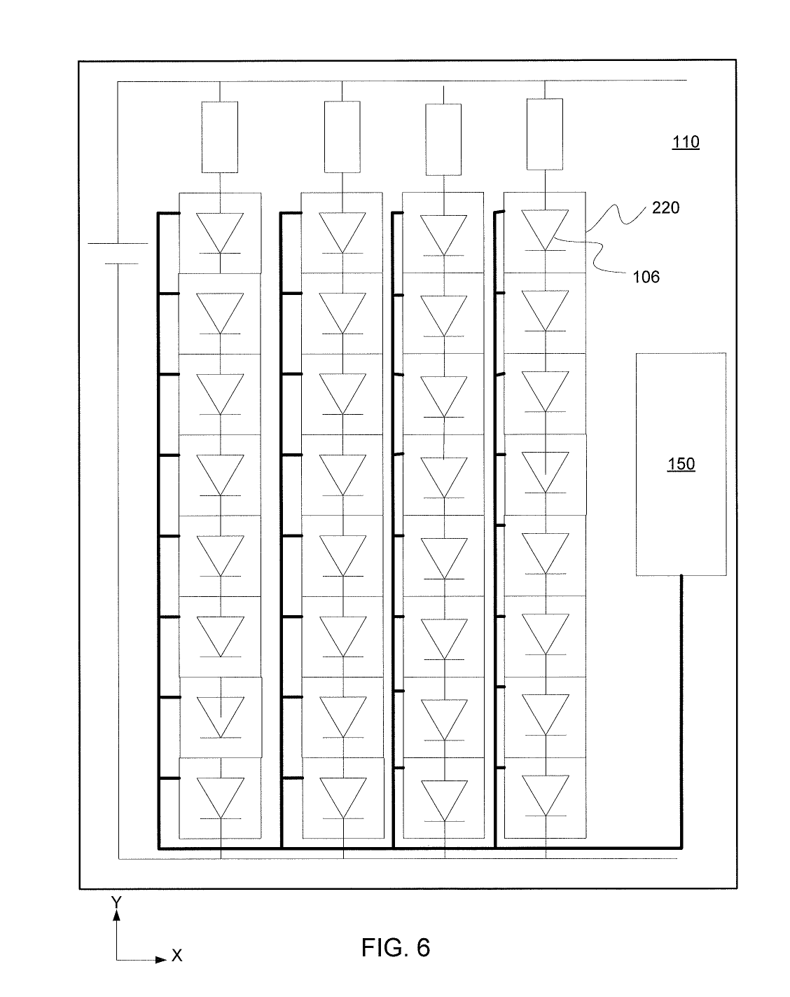

FIG. 6 shows another embodiment where processor system 150 may control each image element 106 by controlling a respective image element mount 220. In this configuration, individual image elements 106 may be dynamically adjusted to control the direction and orientation of the signals emitted by the image elements. For example, processor system 150 may produce signals to instruct components (not shown) to rotate each image element mount 220 about an axis in the x-direction and/or an axis in the y-direction.

Thus, for example, as shown in FIG. 3, computer system 100 may execute processes that control display device arrangement 110 (either alone or via processor system 150) to adjust the direction of the signals emitted from image elements 106 to face the direction and orientation of different users. Thus, user 310 may view information from areas 1-4, while user 320 may view information displayed in areas 5 and 6. In certain aspects, the dynamic adjustments may be made such that one user cannot view the information displayed to the other user (e.g., user 310 cannot view the information in areas 5 and 6 and user 320 cannot view the information in areas 1-4). These embodiments may be configured and implemented with the multiple active application features of the disclosed embodiments to selectively and dynamically control which active applications are displayed to certain users.

In another embodiment, if, as explained above, computer system 100 is configured to detect the presence of user(s) within a determined range of the display device arrangement 110, computer system 100 may execute processes that automatically and dynamically adjust the angle of certain image element mounts associated with the display of certain active applications, thus controlling the view of the active application to the user(s). Returning to the example of FIG. 3, computer system 100 may determine (e.g., based on RFID or another technology) a distance that user 320 is from display arrangement 300. Based on the determined distance and an estimated or known height of user 320 (which may be stored at computer system 100 for example), computer system 100 may calculate an angle at which to adjust image element mounts (115, 220) associated with areas 5 and 6 to control the view of the applications displayed in those areas in a manner that allows user 320 to view them clearly.

In certain embodiments, the dynamic adjustment of image element mounts (115, 220) may be provided using magnetic technologies, e.g., magnets may be electrically controlled to repel or attract the substrate of the image element mount based on control signals provided by processor system 150. Alternatively, electro-mechanical mechanisms (such as one or more microelectromechanical systems (MEMS)) can be used to actuate the movement of each image element mount. Other mechanisms known to one of ordinary skill in the art may be implemented to provide the capability for each image element mount to be selectively and dynamically controlled for physically adjusting the position image element mounts (115, 220).

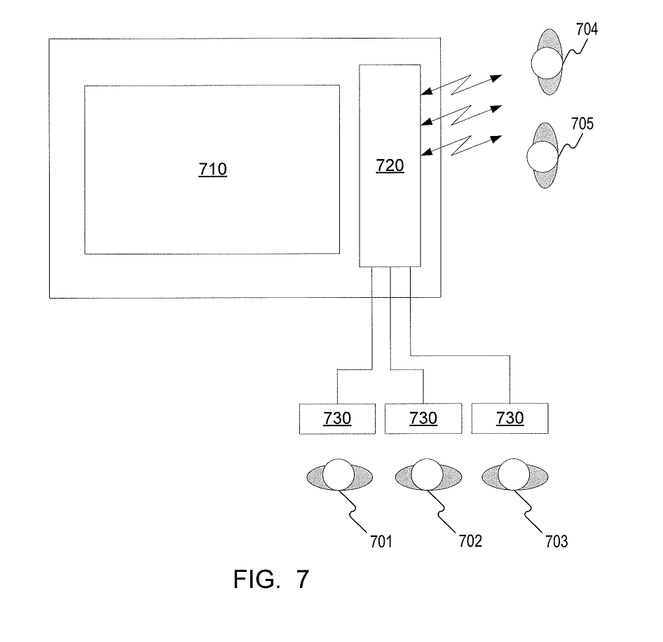

FIG. 7 shows a block diagram of an exemplary arrangement that provides for multiple user input to the display arrangement. In one example, the system shown in FIG. 7 may be similar to that of computer system 100 as described herein. In this example, a display arrangement 710 may interface with an interface component 720 that is configured to receive and control input from (and output to) one or more users (E.g., users 701-705). In certain embodiments, interface component 720 may be configured to use wireless and/or wired technologies to enable individual users to manipulate active applications. For example, users 701-703 may each use respective keyboards 730 to provide input to active application(s) displayed by the system. Interface component 720 may also be configured to receive (and send) wireless data to allow users 704-705 to manipulate respective active applications. Other configurations and components may be implemented without departing from the scope of the disclosed embodiments. For example, interface component 720 may include two or more sub-components that are dedicated to handling input from one or more of the users interfacing with display arrangement 710, e.g., by entering commands using a touch-screen capability of display arrangement 710.

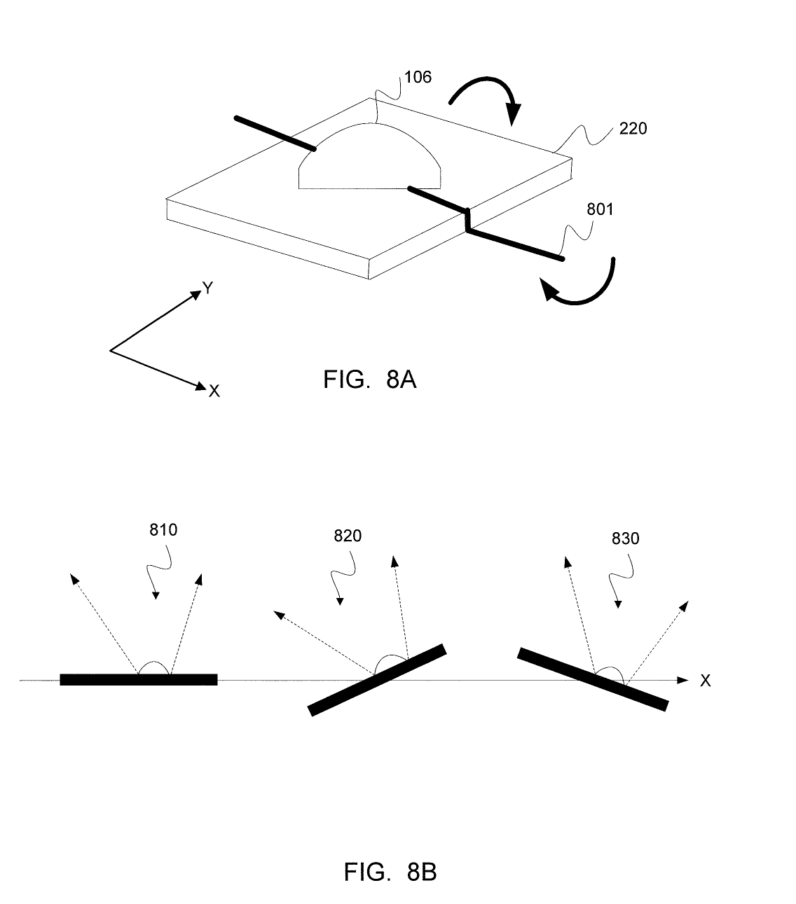

FIG. 8A shows a block diagram of an exemplary image element mount 220 that is dynamically adjustable in accordance with the disclosed embodiments. In one example, the image element mount(s) may be formed of a flexible substrate to avoid damage to the circuitry associated with image elements. Further, a flexible circuit path 801 may be used to electrically connect image element 106 to the circuitry providing display functionality, even as image element mount 220 is rotated. Thus, image element mount 220 may be capable of being rotated about the x- and/or y-axes as shown in FIG. 8A based on commands received from processor system 150.

FIG. 8B shows various exemplary positions 810, 820, and 830 in which dynamically adjustable image element mount 220 may be positioned when controlled by computer system 100 and/or processor system 150. For example, FIG. 8B shows three exemplary positions along the x-axis. In position 810, image element mount 220 is not rotated about the x-axis. In position 820, image element mount 220 is rotated about the x-axis in a first direction, and in position 830, image element mount 220 is rotated about the x-axis in a second direction. While FIG. 8B only shows rotation in one dimension, image element mount 220 may be similarly rotated about the y-axis.

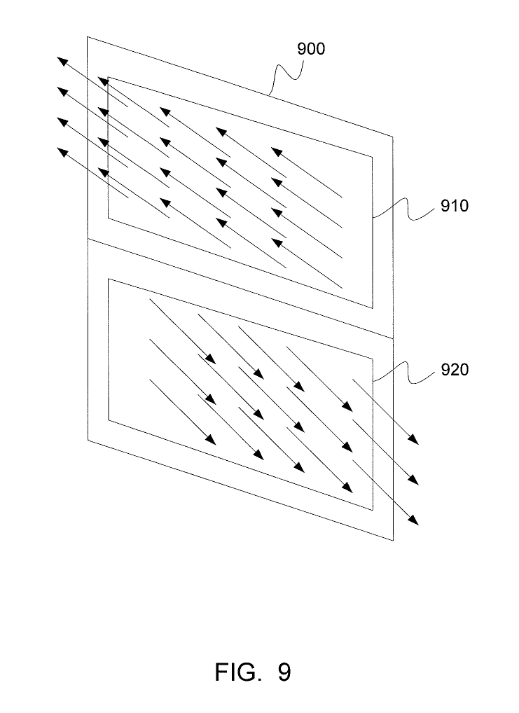

FIG. 9 shows a block diagram illustrating the dynamic image element controls for a portion of a display arrangement 900, consistent with disclosed embodiments. For example, computer system 100 or processor system 150 may execute software that performs adjustments to selected groups of image elements to control the direction in which information is emitted and rendered by the image elements, in accordance with one or more embodiments discussed above. In FIG. 9, computer system 100 may control elements mounts located in display area 910 to rotate such that they emit signals that are used to render content in a left most direction. Computer system 100 or processor system 150 may also control elements located in display area 920 to rotate such that such that they emit signals that are used to render content in a right most direction at the same time the elements in the first portion are displaying information in the left most direction.

The foregoing descriptions have been presented for purposes of illustration and description. They are not exhaustive and do not limit the disclosed embodiments to the precise form disclosed. Modifications and variations are possible in light of the above teachings or may be acquired from practicing the disclosed embodiments. For example, the described implementation includes software, but the disclosed embodiments may be implemented as a combination of hardware and software or in hardware alone. Additionally, although disclosed aspects are described as being stored in a memory on a computer, one skilled in the art will appreciate that these aspects can also be stored on other types of computer-readable media, such as secondary storage devices, like hard disks, floppy disks, a CD-ROM, or other forms of RAM or ROM. In addition, an implementation of software for disclosed aspects may use any variety of programming languages, such as Java, C, C++, JavaScript, or any other now known or later created programming language.

Other embodiments will be apparent to those skilled in the art from consideration of the specification and practice of the embodiments disclosed herein. It is intended that the specification and examples be considered as exemplary only, with the true scope and spirit being indicated by the following claims.

What is claimed is:

1. A computer system for providing control for multiple active applications, comprising:
a storage device storing instructions; and
one or more computer processors configured to execute the instructions in the storage device to:
provide control of a first active application displayed in a display device for the computer system,
provide control of a second active application displayed in the display device, and
process input from a first user to manipulate the first active application while simultaneously processing input from a second user to manipulate the second active application.

2. The computer system of claim 1, the one or more computer processors being further configured to:
receive a command to open a third active application; and
process input to manipulate the third active application while simultaneously processing input to manipulate the first application and the second application.

3. The computer system of claim 1, the one or more computer processors being further configured to:
cause the display device to display the first active application on a first area of a display device and the second active application on a second area of the display device.

4. The computer system of claim 3, the one or more computer processors being further configured to:
receive a command to split the first area into two sub-areas;
receive a command to open a third active application; and
cause the display device to split the area into two sub-areas and display the first active application in the first sub-area and the third active application in the second sub-area.

5. The computer system of claim 1, the one or more computer processors being further configured to:
determine that a third user, who is not authorized to view the first active application, is within a determined distance from the computer system; and
cause the display device to cease displaying the first active application in response to the determination that the third user who is not authorized to view the first active application is within the determined distance from the computer system.

6. The computer system of claim 1, the one or more computer processors being further configured to:
cause the display device to display the first active application in a first orientation based on a detected location of the first user; and
cause the display device to display the second active application in a second orientation based on a detected location of the second user.

7. The computer system of claim 6, the one or more computer processors being further configured to:
receive a command from the first user to change the orientation of the first active application, such that the first application is viewable by the second user; and
cause the display device to display the first active application in the new orientation.

8. The computer system of claim 1, the one or more computer processors being further configured to:
cause the display device to display the first active application by a first group of image elements and to display the second application by a second group of image elements,
cause the display device to rotate the first group of image elements about one or more axes based on a detected location of the first user; and
cause the display device to rotate the second group of image elements about the one or more axes based on a detected location of the second user.

9. The computer system of claim 8, the one or more computer processors being further configured to:
cause the display device to rotate the first group of image elements so that the first area is viewable by the first user but not viewable by the second user.

10. A computer-implemented method for providing control for multiple active applications, comprising:
providing, by one or more computer processors, control of a first active application displayed in a display device for the computer system,
providing, by the one or more computer processors, control of a second active application displayed in the display device, and
processing, by the one or more computer processors, input from a first user to manipulate the first active application while simultaneously processing input from a second user to manipulate the second active application.

11. The computer-implemented method of claim 10, further comprising:
receiving a command to open a third active application; and
processing input to manipulate the third active application while simultaneously processing input to manipulate the first application and the second application.

12. The computer-implemented method of claim 10, further comprising:
displaying the first active application on a first area of a display device and the second active application on a second area of the display device.

13. The computer-implemented method of claim 12, further comprising:
receiving a command to split the first area into two sub-areas;
receiving a command to open a third active application; and
generating instructions to split the area into two sub-areas and display the first active application in the first sub-area and the third active application in the second sub-area.

14. The computer-implemented method of claim 10, further comprising:
determining that a third user, who is not authorized to view the first active application, is within a determined distance from the computer system; and
ceasing display of the first active application based on the determination that the third user who is not authorized to view the first active application is within the determined distance from the computer system.

15. The computer-implemented method of claim 10, further comprising:
displaying the first active application in a first orientation based on a detected location of the first user; and
displaying the second active application in a second orientation based on a detected location of the second user.

16. The computer-implemented method of claim 15, further comprising:
receiving a command from the first user to change the orientation of the first active application, such that the first application is viewable by the second user; and
displaying the first active application in the new orientation.

17. The computer-implemented method of claim 10, further comprising:
displaying the first active application by a first group of image elements and the second application by a second group of image elements,
rotating the first group of image elements about one or more axes based on a detected location of the first user; and
rotating the second group of image elements about the one or more axes based on a detected location of the second user.

18. The computer-implemented method of claim 17, further comprising:
rotating the first group of image elements so that the first area is viewable by the first user but not viewable by the second user.

19. A computer system for providing dynamically adjustable image elements, comprising:
a display arrangement including a group of image elements that are each mounted on an image element mount; and
a computer processor configured to execute software instructions that provide control signals to the image element mounts to selectively and dynamically control rotational angles of the image element mounts within the display arrangement.

20. The computer system of claim 19, the computer processor further configured to execute the software instruction to:
provide control signals to a first subset of the image element mounts to control the rotational angles of the first subset of the image element mounts based on a detected location of a first user; and
provide control signals to a second subset of the image element mounts to control the rotational angles of the first subset of the image element mounts based on a detected location of the second user.
